(19) United States
(12) Patent Application Publication
(10) Pub. No.: US 2014/0067703 A1
(43) Pub. Date: Mar. 6, 2014

(54) TALENT ACQUISITION SYSTEM AND METHOD

(71) Applicants: Tanja BAECK, Wiesloch (DE); Elmar PAUL, Angelbachtal (DE); S. M. Fazlul HOQUE, Mannheim (DE); Silke Storch, Rauenberg (DE); Bertram Wiest, Heidelberg (DE)

(72) Inventors: Tanja BAECK, Wiesloch (DE); Elmar PAUL, Angelbachtal (DE); S. M. Fazlul HOQUE, Mannheim (DE); Silke Storch, Rauenberg (DE); Bertram Wiest, Heidelberg (DE)

(73) Assignee: SAP AG, Walldorf (DE)

(21) Appl. No.: 13/603,149

(22) Filed: Sep. 4, 2012

(51) Int. Cl. G06Q 10/06

(52) U.S. Cl. 705/321

(57) ABSTRACT

Embodiments of the present invention may provide a system and method for matching candidates to a job position opening. Embodiments may include automatically creating a virtual profile based on shared characteristics of known top performing employees; matching candidates to the virtual profile; and outputting the matching results. Therefore, in addition to finding qualified candidates, embodiments of the present invention may find candidates best suited to succeed at the job based on matches to shared characteristics of known top performers.

### FIELD OF THE INVENTION

The disclosure relates to a system and method for talent acquisition based on match indicators to known top performing talent.

### BACKGROUND

All employers wish to employ the most qualified and talented employees to fit their needs; however, finding top talents is often difficult and cumbersome. Some job matching systems match the minimum requirements of a job position to a pool of candidates that apply for the job position. These systems tend not to be conducive to finding top talent candidates because top talent candidates rarely actively apply for jobs. Thus, employers tend to proactively search for top talents.

Also, merely matching candidates to the minimum requirements of a job position (e.g., education, work experience, etc.) is not a good indicator of the candidate's talents and the potential of the candidate succeeding at the job position. For example, a candidate may have the qualifications for a particular job position but may be a wrong fit for the employer's work environment and culture. Therefore, there is a need in the art for improved talent searching for top talents that will have the best chances to succeed.

### BRIEF DESCRIPTION OF THE DRAWINGS

FIG. 1 illustrates a block diagram according to a system according to an embodiment of the present invention.

FIG. 2 illustrates a process for matching candidates to a job position according to an embodiment of the present invention.

FIG. 3 illustrates an exemplary user interface display according to an embodiment of the present invention.

FIG. 4 illustrates a computer structure according to an embodiment of the present invention.

### DETAILED DESCRIPTION

Embodiments of the present invention may provide a method for matching candidates to a job position opening. The method may include automatically creating, by a processor, a virtual profile based on shared characteristics of known top performing employees; matching candidates to the virtual profile; and outputting the matching results. Therefore, in addition to finding qualified candidates, embodiments of the present invention may find candidates best suited to succeed at the job based on matches to shared characteristics of known top performers.

Embodiments of the present invention may provide a system including a memory to store program instructions and a processor coupled to the memory. The processor may execute the program instructions to generate a virtual profile based on shared characteristics of known top performing employees, and to match candidates to the virtual profile.

Embodiments of the present invention may provide a non-transitory medium to storing instructions adapted to be executed by a processor to perform a method. The method may include creating a virtual profile based on shared characteristics of known top performing employees; matching candidates to the virtual profile; and outputting the matching results. Therefore, in addition to finding qualified candidates, embodiments of the present invention may find candidates best suited to succeed at the job based on matches to shared characteristics of known top performers.

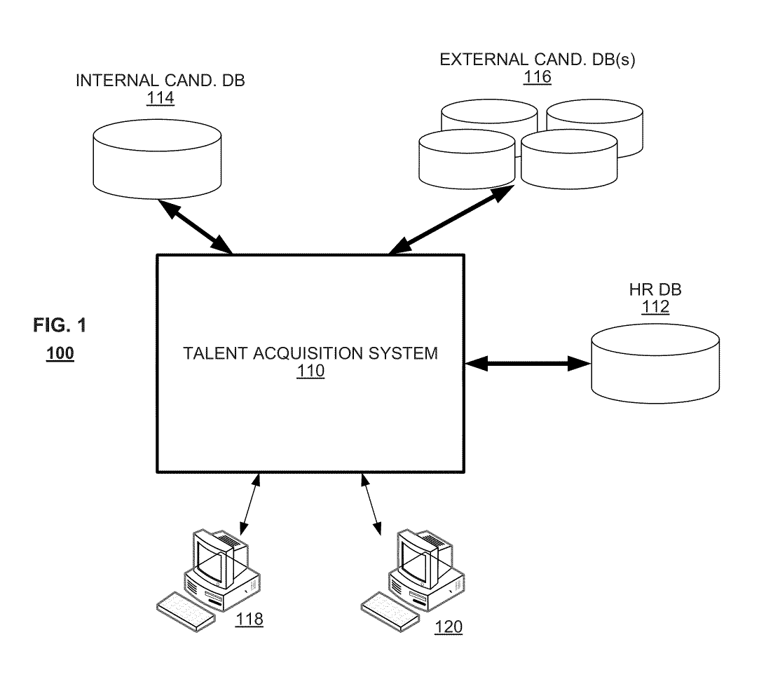

FIG. 1 illustrates a block diagram of a system 100 according to an embodiment of the present invention. The system 100 may include a talent acquisition system (TAS) 110, a human resources database (HR DB) 112, an internal candidates database (DB), external candidate database(s) (DB(s)), and user terminals 118, 120. The TAS 110 may be provided as a server provider. In an embodiment, the TAS 110 may be a cloud computing based component that is accessible by user terminals 118, 120.

The TAS 110 may be coupled to the HR DB 112. Bi-directional communication may be supported between the TAS 110 and HR DB 112. For example, the TAS 110 may request information from the HR DB 112, and the HR DB 112 may transmit the requested information to the TAS 110. The communication between the TAS 110 and HR DB 112 may be provided by a wired communication protocol, a wireless communication protocol, or a combination thereof.

The HR DB 112 may store employee information. In an embodiment, the HR DB 112 may store employee information categorized by their job position or grouped with similar job positions. In an embodiment, the HR DB 112 may store employee reviews such as yearly reviews. The HR DB 112 may also include a list of rankings of employees organized by their job position or similar job positions. In an embodiment, the rankings may be based on employee reviews, management rankings or other suitable means. The rankings may identify top performing employees. For example, top performing employees may be identified as the top ten percent in each job position or similar job positions. In another embodiment, top performing employees may be identified by management and a corresponding tag in the employee's information may reflect their top performer status.

The HR DB 112 may also store employee profiles. The employee profiles may include employee characteristics such as professional credentials, personal hobbies, languages spoken, club memberships, career progression performance, etc. In an embodiment, the employee profiles may be created and updated by the employee themselves or the employee profiles may be created and updated by HR department or any combination thereof.

The TAS 110 may be coupled to the internal candidates DB 114. Bi-directional communication may be supported between the TAS 110 and the internal candidates DB 114. For example, the TAS 110 may request information from the internal candidates DB 114, and the internal candidates DB 114 may transmit the requested information to the TAS 110. The communication between the TAS 110 and internal candidates DB 114 may be provided by a wired communication protocol, a wireless communication protocol, or a combination thereof.

The internal candidates DB 114 may store internal candidates information (i.e., candidates from within the company). In an embodiment, the internal candidates information may include employee profiles of employees in consideration for an open job position. The employees included in the internal candidates DB 114 may be based on employees applying for open job positions themselves or may be based on management identification of possible candidates or a combination thereof. In an embodiment, the internal candidates DB 114 may be integrated with the HR DB 112.

The TAS 110 may be coupled to external candidates DB(s) 116. Bi-directional communication may be supported between the TAS 110 and external candidates DB(s) 116. For example, the TAS 110 may request information from the external candidates DB(s) 116, and the external candidates DB(s) 116 may transmit the requested information to the TAS 110. The communication between the TAS 110 and external candidates DB(s) 116 may be provided by a wired communication protocol, a wireless communication protocol, or a combination thereof.

The external candidates DB(s) 116 may include an internal recruiting system storing applications submitted by external candidates and/or may include third party systems accessible by the TAS 110. The external candidates DB(s) 116 may include public and/or private third party systems. The external candidates DB(s) 116, for example, may include third party job searching systems where open job positions are posted and interested candidates can apply to or where professionals post their resumes and credentials. The external candidates DB(s) 116 may also include social networking systems, where potential candidate information may be stored and extracted without the candidate actively applying for the job. For example, the external candidates DB(s) 116 may include professional networking systems.

Users, for example recruiters, may access the TAS 110 via user terminals 118, 120. Although FIG. 1 illustrates two user terminals, any number of user terminals may be provided. The user terminals 118, 120 may communicate with the TAS 110 via a wired communication protocol, a wireless communication protocol, or a combination thereof. The user terminals 118, 120 may be provided as computers, laptops, smartphones, personal digital assistants, tablets, notebooks, mini-notebook computers, or other suitable computing devices. Moreover, the user terminals 118, 120 may receive user input data and participate in execution of program instructions for the TAS 110.

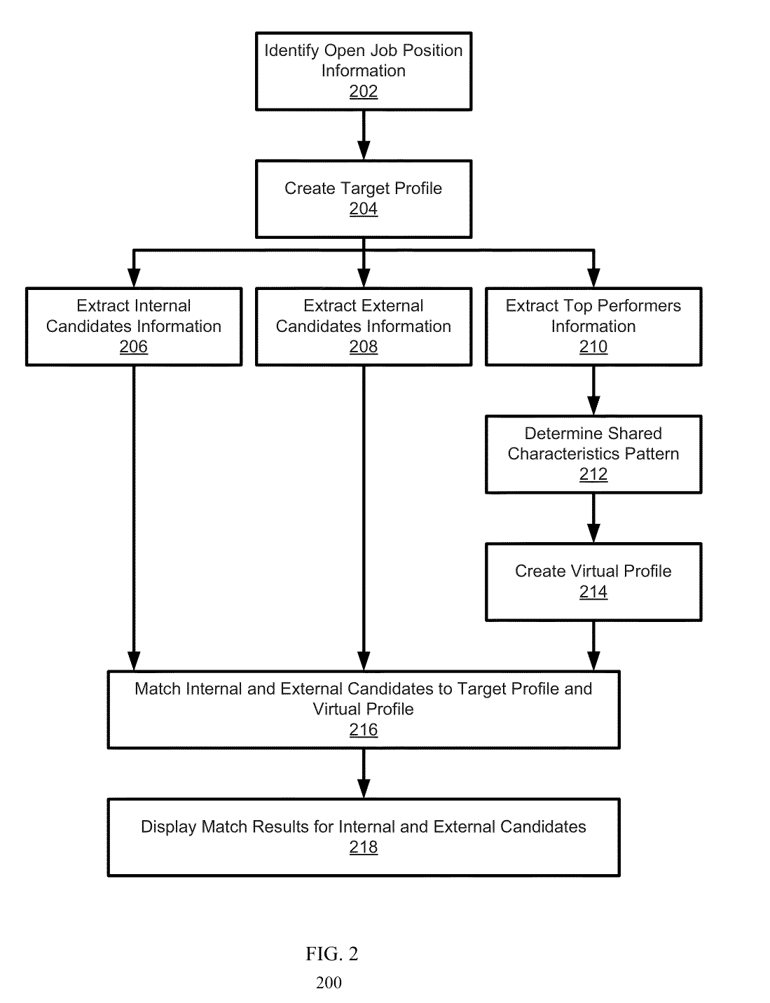

FIG. 2 illustrates a process 200 for matching candidates for a job position opening according to an embodiment of the present invention. The process 200 may be performed by the TAS 110 of FIG. 1 in an embodiment. In step 202, an open job position information may be identified. The open job position information may be posted by a hiring manager or the like, and may include desired job qualifications and/or other job related information. For example, the open job position information may include information such as desired education level, work experience, language fluency, job location, salary, start date, etc.

In step 204, a target profile may be created based on the job position information such as minimum requirements or credentials. The target profile may include desired characteristics of potential candidates to fill the job position information. After creation, the target profile may be stored.

In step 206, internal candidates information may be extracted. Internal candidates may refer to current employees of the company. In an embodiment, the internal candidates information may be extracted from their employee profiles or submitted resumes or other known information source

In step 208, external candidates information may be extracted. External candidates may refer to candidates that are not currently employees of the company. In an embodiment, external candidate information may be extracted from the company's internal recruiting systems and/or third party systems (e.g., job searching systems, social networks, etc.) described above.

In step 210, information for the top performing employees in the same or similar job position as the open job position may be extracted. In an embodiment, the top performing employees information may be extracted from the HR DB. As described above, the top performing employees may be identified according to employee reviews, management rankings, tags, etc. Also, the top performance employees information may be extracted from their employee profiles, which may include information related to the job position information but may also include other employee information. For example, top performing employee characteristics such as professional credentials (e.g., performance over time), personal hobbies, languages spoken, club memberships, etc., may be extracted.

In step 212, common (shared) characteristics of the top performers may be determined. For example, a correlation algorithm may be applied to the extracted information to find common characteristics. In an embodiment, common patterns may also be determined. For example, the correlation algorithm may identify that the top performers share a common professional promotion path such as being promoted to manager within five years.

In step 214, a virtual profile may be automatically created based on the determined shared characteristics and/or patterns of the top performers. In an embodiment, the virtual profile may be automatically created by executing an algorithm based on available profiles of the top performers. Therefore, a virtual profile may be a composite of shared characteristics and/or patterns of the top performers in the same or similar job position. Moreover, while the virtual profile may include some common elements as the target profile, the virtual profile may also include additional elements not included in the target profile. For example, a target profile for a marketing associate may include a minimum education level (say, Bachelors degree), minimum work experience (say, 5-10 years), and language fluency (say, English). A virtual profile for the same market associate position based on a composite of shared characteristics/patterns of top performers in the same or similar position may include desired work experience of 7-12 years with a promotion every three years, a masters level education, membership to a particular marketing association, and having a hobby of fly fishing. After creation, the virtual profile may be stored. In an embodiment, the virtual profile may be stored concurrently with open job position status or, alternatively, beyond the open job position closing. In an embodiment, the virtual profile may updated over time with new top performer information.

In step 216, internal and external candidates information may be compared to and matched with the target and virtual profiles created. In step 218, the match results for the internal and external candidates may be outputted. The match results may be displayed to a recruiter and may provide the recruiter with more valuable information than conventional systems. While the target profile matches may indicate a candidate's qualification level for the job position, the virtual profile matches may indicate a candidate's potential for success at the job position based on similarities to already known top performers. This valuable insight may allow the recruiter to better source talents efficiently where candidates would have the best opportunity to succeed, thus improving company performance.

In another embodiment, only internal or external candidates may be used in the process 200 based on the job position information. For example, the company may wish to only consider internal candidates for a particular job position. Alternatively, the company may wish to only consider external candidates for a particular job position.

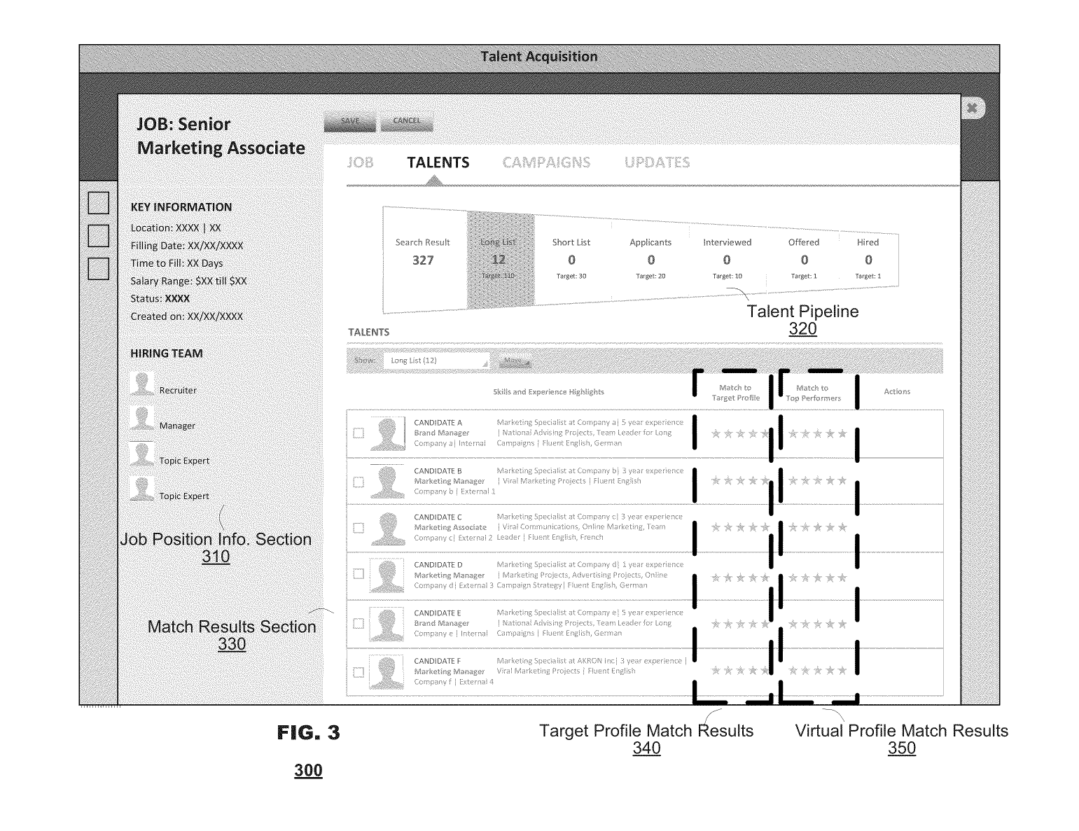

FIG. 3 illustrates an exemplary user interface display 300 of match results according to an embodiment of the present invention. In an embodiment, the display 300 may be provided by the TAS 110 on the user terminals 118, 120 of FIG. 1 upon execution of process 200 of FIG. 2 for example. The display 300 may include a job position information section 310, a talent pipeline 320, and a match results section 330. The match results section 330 may include target profile match results 340 and virtual profile match results 350.

The job position information section 310 may include identification information relating to the open job position. The identification information may include job characteristics such as location, salary range, status, etc., and may include hiring personnel information such as recruiter, manager, etc. The talent pipeline 320 may provide a graphical representation of a talent acquisition process. The talent pipeline 320 may include different phases from the initial search to the hiring of the talent. For example, talent pipeline 320 may include phases of search results that include long and short lists, applicants, interviewed, offered, and hired as shown in FIG. 3. Other phases not shown may also be included. The graphical representation of the phases may also include a target quantity that may represent a desired quantity for the particular phase and an actual quantity that may represent the current quantity for the particular phase. For example, FIG. 3 shows a target quantity of “110” for the long list phase while the actual quantity is “12” in this example. Moreover, the talent pipeline 320 may provide a designation to the current display. For example, a phase in the talent pipeline 320 may be highlighted such as the long list phase in the FIG. 3 example.

The match results section 330 may display information relating to match results of possible candidates to both the target profile and virtual profile. The candidates list order may be customizable. For example, the candidates list may be listed in order of their degree of matches to the target profile or, alternatively, in order of their degree of matches to the virtual profile. The candidates list may also display brief description and/or pictures of the candidates. The match results section 330 may include target profile match results 340 that are the results of the comparison between the candidates and the target profile for the particular job position. The target profile, as described above, may be based on job credentials desired for the job position. The target profile match results 340 may be provided with a graphical representation of the degree of matches. For example, a star rating system is shown in FIG. 3 to indicate the degree of matches. Alternatively, other graphical, numerical, textual, or other suitable representations may be provided to show degree of matches.

The match results section 330 may also include virtual profile match results 350 that are the results of the comparison between the candidates and the virtual profile for the particular job position. The virtual profile, as described above, may be a composite of shared characteristics of top performers at the same or similar job position. The virtual profile match results 350 may be provided with a graphical representation of the degree of matches. For example, a star rating system is shown in FIG. 3 to indicate the degree of matches. Alternatively, other graphical, numerical, textual, or other suitable representations may be provided to show degree of matches.

The target and profile match results 340, 350 may provide a quick visual tool to assist the recruiter in the talent acquisition process. The results may assist the recruiter in finding talent that is best suited for the company. For example, multiple candidates may be high matches to the target profile, but the virtual profile match results 350 may provide a better indicator as to the suitability of the candidates to succeed in the company because of the candidates similarities to already known top performers in the company. Thus, the match results tool may lead to better talent acquisition and lower turnover at the company.

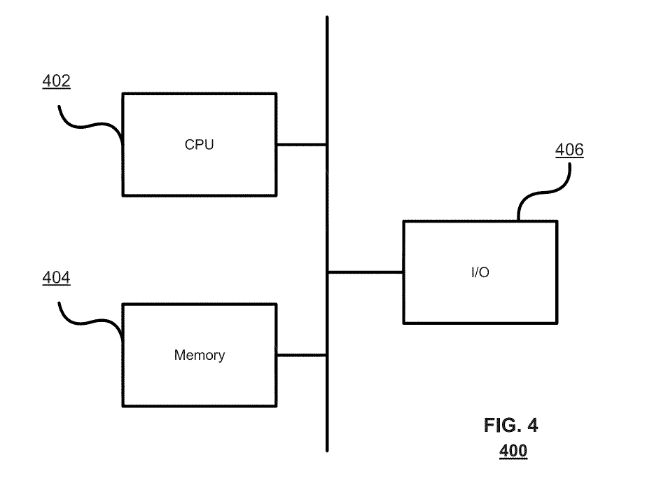

FIG. 4 illustrates a structure of a computer server 400 for talent acquisition system (for example, TAS 110 of FIG. 1) according to an exemplary embodiment of the present invention. The computer server 400 may include a processor 402, a memory 404, and an I/O device(s) 406. The processor 402 may be coupled to the memory 404 and I/O device(s) 406. These connections may be direct or via other internal electronic circuitry or components.

The processor 402 may be a programmable processor that executes instructions residing in the memory 404 to receive and send data via the I/O device(s) 406. The instructions may perform the operations of talent acquisition as described herein. The term programmable processor as used herein may be any programmable microprocessor or processor or combination of microprocessors or processors that can operate on digital data, which may be special or general purpose processors coupled to receive data and instructions from, and to transmit data and instructions to, a machine-readable medium.

Memory 404 is a machine-readable medium that stores data that may be processed by processor 402. The term machine-readable medium as used herein may be any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 402 via one or more I/O device(s) 406.

The I/O device(s) 406 may be one or more input/output interfaces that receive and/or send digital data to and from an external device. Interfaces as used herein are any point of access to an external device where digital data is received or sent, including ports, buffers, queues, subsets thereof, or any other interface to an external device.

The exemplary method(s) and computer program instructions described herein may be embodied on a machine readable storage medium such as a computer disc, optically-readable media, magnetic media, hard drives, RAID storage device, and flash memory. In addition, a server or a database server may include machine readable media configured to store machine executable program instructions. The features of the disclosed embodiments may be implemented in hardware, software, firmware, or a combination thereof and utilized in systems, subsystems, components or subcomponents thereof. When implemented in software, the elements of the disclosed embodiments are programs or the code segments used to perform the necessary tasks. The program or code segments can be stored on machine readable storage media. The “machine readable storage media” may include any medium that can store information. Examples of a machine readable storage medium may include electronic circuits, semiconductor memory device, ROM, flash memory, erasable ROM (EROM), floppy diskette, CD-ROM, optical disk, hard disk, fiber optic medium, any electromagnetic storage device, or optical. The code segments may be downloaded via computer networks such as Internet, Intranet, etc. The disclosed embodiments may be used in a semantic business application solution to support context-related search in SAP business applications (e.g., SAP ERP, SAP CRM, etc.) and/or non-SAP systems. The business knowledge provided by a semantic network can be used by all business applications, e.g. as a semantic extension.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

1. A computer-implemented method for matching candidates to a job position opening, comprising:
automatically creating, by a processor, a virtual profile based on shared characteristics of known top performing employees;
matching candidates to the virtual profile; and
outputting the matching results.

2. The method of claim 1, wherein the characteristics includes shared patterns in top performing employees' records.

3. The method of claim 1, wherein the candidates include internal candidates and external candidates.

4. The method of claim 3, wherein external candidates' information is extracted from third party systems.

5. The method of claim 4, wherein the third party systems include a social networking system.

6. The method of claim 1, further comprises
extracting employee profiles of top performing employees; and
determining shared characteristics of top performing employees based on the employee profiles.

7. The method of claim 1, further comprises
creating a target profile based on credential requirements for the job position opening;
matching candidates to the target profile;
outputting the target profile matching results.

8. A system, comprising:
a memory to store program instructions; and
a processor, coupled to the memory,
to generate a virtual profile based on shared characteristics of known top performing employees, and
to match candidates to the virtual profile.

9. The system of claim 8, wherein the system is a computer server.

10. The system of claim 8, wherein candidates' information is retrieved from internal and external systems.

11. The system of claim 8, the characteristics includes shared patterns in top performing employees' records.

12. The system of claim 8, wherein the system extracts candidates' information from an external system.

13. The system of claim 12, wherein the external system is a social networking system

14. A non-transitory machine-readable medium storing instructions adapted to be executed by a processor to perform a method comprising:
creating a virtual profile based on shared characteristics of known top performing employees;
matching candidates to the virtual profile; and
outputting the matching results.

15. The non-transitory machine-readable medium of claim 14, wherein the characteristics includes shared patterns in top performing employees' records.

16. The non-transitory machine-readable medium of claim 14, wherein the candidates include internal candidates and external candidates.

17. The non-transitory machine-readable medium of claim 16, wherein external candidates' information is extracted from third party systems.

18. The non-transitory machine-readable medium of claim 17, wherein the third party systems include a social networking system.

19. The non-transitory machine-readable medium of claim 14, further comprises
extracting employee profiles of top performing employees; and
determining shared characteristics of top performing employees based on the employee profiles.

20. The non-transitory machine-readable medium of claim 14, further comprises
creating a target profile based on credential requirements for the job position opening;
matching candidates to the target profile;
outputting the target profile matching results.
